(19) United States
(12) Patent Application Publication
(10) Pub. No.: US 2026/0186675 A1
(43) Pub. Date: Jul. 2, 2026

(54) METHOD AND DEVICE WITH MEMORY MANAGEMENT

(71) Applicant: Samsung Electronics Co., Ltd., Suwon-si (KR)

(72) Inventors: Sunghoon SON, Suwon-si (KR); Ruth KIM, Suwon-si (KR); Dong-Uk RYU, Suwon-si (KR); Sungduk CHO, Suwon-si (KR)

(73) Assignee: Samsung Electronics Co., Ltd., Suwon-si (KR)

(21) Appl. No.: 19/268,684

(22) Filed: Jul. 14, 2025

(30) Foreign Application Priority Data
Dec. 27, 2024 (KR) 10-2024-0198530

(51) Int. Cl. G06F 3/06

(52) U.S. Cl. CPC G06F 3/0631; G06F 3/0613; G06F 3/0656; G06F 3/0659; G06F 3/0673

(57) ABSTRACT

A processor-implemented method includes allocating a user buffer and performing data read when starting data transmission in response to an application start signal, determining whether a memory usage pattern to occur in the data transmission is secured, providing a transmission order and memory information based on a result of the determination and the memory usage pattern, and transmitting data based on the transmission order and the memory information.

### CROSS-REFERENCE TO RELATED APPLICATIONS

This application claims the benefit under 35 USC § 119(a) of Korean Patent Application No. 10-2024-0198530, filed on Dec. 27, 2024 in the Korean Intellectual Property Office, the entire disclosure of which is incorporated herein by reference for all purposes.

### BACKGROUND

### 1. Field

The following description relates to a method and device with memory management.

### 2. Description of Related Art

In a parallel computing environment, data management and memory utilization methods may determine the performance and efficiency of a system that processes big data. Specifically, in a parallel processing program, data transfer and memory management schemes may have a significant impact on the speed and accuracy of node-to-node communication. Memory allocation and buffer management methods may enable efficient use of resources in a data transmission process.

A network traffic processing or high-performance computing environment may require a method of dynamically allocating a memory based on a data transmission pattern or a method of improving the transmission efficiency by optimizing an iteratively used memory space. The memory management method may redistribute resources by analyzing the data size, transmission order, and usage frequency or may minimize memory usage.

In addition, a method used for node-to-node or device-to-device data transmission may focus on optimizing network bandwidth and system resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes allocating a user buffer and performing data read when starting data transmission in response to an application start signal, determining whether a memory usage pattern to occur in the data transmission is secured, providing a transmission order and memory information based on a result of the determination and the memory usage pattern, and transmitting data based on the transmission order and the memory information.

The allocating of the user buffer and the performing of the data read may include pre-determining a maximum memory size and dynamically allocating a buffer based on the size.

The allocating of the user buffer and the performing of the data read may include determining a data write order by analyzing a data access frequency that occurs during the data transmission.

The method may include, in response to the memory usage pattern not being identified according to the determination, performing an iterative pattern storage process of identifying and storing an iterative pattern.

The iterative pattern storage process may include storing a maximum memory size, a usage count of each memory, and a memory usage order, dynamically allocating a library buffer based on a storage result, retrieving data specified by a data source device by accessing the library buffer, and transmitting the specified data to a transmission target node or device.

The performing of the iterative pattern storage process may include, in response to the data transmission being completed, identifying a maximum memory size and securing a transmission order list.

The transmitting of the data based on the transmission order and the memory information may include in response to an available memory space exceeding a threshold value, performing an asynchronous data transmission process, and in response to the available memory space being less than or equal to the threshold value, performing a synchronous data transmission process.

The asynchronous data transmission process may include preparing a memory pool based on the transmission order list, and invoking a memory allocation space corresponding to the transmission order.

The memory pool may be dynamically adjusted corresponding to the available memory space.

The synchronous data transmission process may include using a maximum memory as a buffer based on the transmission order list and the memory information.

The method may include copying data to be transmitted according to the asynchronous data transmission process or the synchronous data transmission process, and transmitting the copied data.

The transmitting of the data based on the transmission order and the memory information may include generating a single shared memory buffer using a global shared memory (GSM), and in response to a memory read/write task occurring among multiple nodes, allocating a memory space corresponding to an access frequency.

In one or more general aspects, an electronic device includes one or more processors configured to allocate a user buffer and perform data read when starting data transmission in response to an application start signal, determine whether a memory usage pattern to occur in the data transmission is secured, provide a transmission order and memory information based on a result of the determination and the memory usage pattern, and transmit data based on the transmission order and the memory information.

For the allocating of the user buffer and the performing of the data read, the one or more processors may be configured to pre-determine a maximum memory size and dynamically allocate a buffer based on the size.

For the allocating of the user buffer and the performing of the data read, the one or more processors may be configured to determine a data write order by analyzing a data access frequency that occurs during the data transmission.

The one or more processors may be configured to, in response to the memory usage pattern not being identified according to the determination, perform an iterative pattern storage process of identifying and storing an iterative pattern.

For the iterative pattern storage process, the one or more processors may be configured to store a maximum memory size, a usage count of each memory, and a memory usage order, dynamically allocate a library buffer based on a storage result, retrieve data specified by a data source device by accessing the library buffer, and transmit the specified data to a transmission target node or device.

For the performing of the iterative pattern storage process, the one or more processors may be configured to, in response to the data transmission being completed, identify a maximum memory size and secure a transmission order list.

For the transmitting of the data based on the transmission order and the memory information, the one or more processors may be configured to in response to an available memory space exceeding a threshold value, perform an asynchronous data transmission process, and in response to the available memory space being less than or equal to the threshold value, perform a synchronous data transmission process.

In one or more general aspects, a parallel processing system includes a plurality of electronic devices each comprising one or more processors, wherein, for each of the electronic devices, the one or more processors comprised in the electronic device may be configured to secure a data size to be used for a data transmission task and an associated order list, determine availability of a memory space of each of the plurality of electronic devices according to the order list, in response to determining that the memory space is sufficient as a result of the determination, perform a parallel processing process based on the order list, in response to determining that the memory space is insufficient as a result of the determination, perform the parallel processing process based on a reconstructed order list by identifying a redundant memory size and reconstructing the order list.

Other features and aspects will be apparent from the following detailed description, the drawings, and the claims.

### BRIEF DESCRIPTION OF THE DRAWINGS

FIG. 1 is a schematic flowchart illustrating a memory management method according to one or more embodiments.

FIG. 2 is a schematic flowchart illustrating a process of storing an iterative pattern according to one or more embodiments.

FIG. 3 is a flowchart illustrating a data transmission process according to one or more embodiments.

FIGS. 4A and 4B are schematic diagrams illustrating a memory management method when a single shared memory buffer is used using a global shared memory (GSM), according to one or more embodiments.

FIGS. 5 to 7 are schematic diagrams illustrating a data transmission process according to an available memory area according to one or more embodiments.

FIG. 8 is a block diagram of an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which the present disclosure pertains and after an understanding of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

The examples may be implemented as various types of products, such as, for example, a personal computer (PC), a laptop computer, a tablet computer, a smart phone, a television (TV), a smart home appliance, an intelligent vehicle, a kiosk, and a wearable device. Hereinafter, embodiments will be described in detail with reference to the accompanying drawings. When describing the embodiments with reference to the accompanying drawings, like reference numerals refer to like elements and a repeated description related thereto will be omitted.

In embodiments, a parallel processing program may divide a computational area into multiple areas and may simultaneously perform computations in each area by various processors. The parallel processing program may ensure a memory space for each processor to transfer data between processors or in the processor and in response to recording data in the secured space, may transmit the data to another processor via a network device. Memory space utilization may have a direct impact on the efficiency of data transmission and computational performance.

Efficient memory management may be an important factor in a data processing process. A method and device of one or more embodiments may optimize resource usage by copying a buffer space allocated by an application program to a software library or a buffer of a hardware device or reducing an iterative memory allocation process during the data transmission. A method and device of one or more embodiments may improve the software performance by analyzing a memory pattern and reusing a space based on a largest memory area. A method and device of one or more embodiments may improve data access speed using direct transfer between memories or using a shared memory and may reduce latency used for data processing.

The memory management method of one or more embodiments may be provided to various targets using an application program in the form of a software library or a software development kit (SDK, thereby reducing the data processing cost and improving the efficiency of program execution.

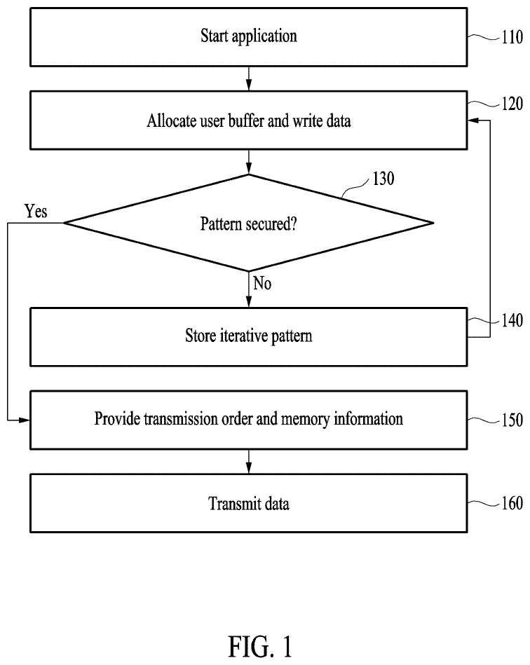

FIG. 1 is a schematic flowchart illustrating a memory management method according to one or more embodiments.

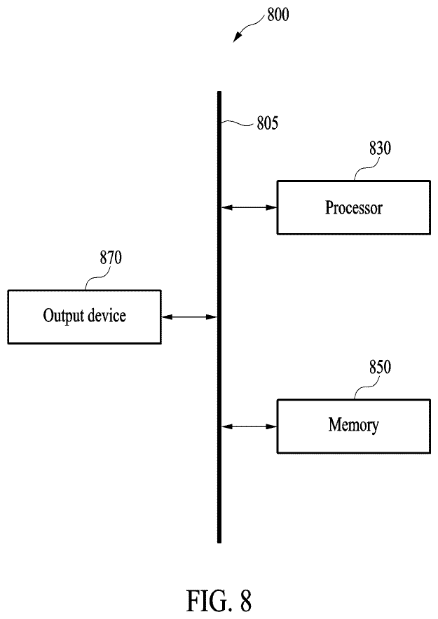

For ease of description, it is described that operations 110 to 160 are performed using an electronic device 800 shown in FIG. 8. However, operations 110 to 160 may be used through any other appropriate electronic device and in any other appropriate system.

Furthermore, operations 110 to 160 of FIG. 1 may be performed in the sequence and manner as illustrated in FIG. 1. However, one or more of the operations may be performed in a different order, one or more of the operations may be omitted, two or more of the operations may be performed in parallel or simultaneously, and/or other operations may be additionally performed without departing from the spirit and scope of the described embodiments.

In the parallel processing environment described in the following embodiments, a node and the electronic device 800 may be used as similar concepts. The node may refer to a device to process data independently in the parallel processing system or perform a computational task. The node may be an electronic device and may include one or more processors, a memory, a storage device, and a network interface and may be regarded as an entity of a computational task that is independently executed.

The electronic device 800 may be a device including hardware configured to process, transmit, store, and manage data and may perform a detailed task in the node. The electronic device 800 may operate as a part of the node to process data or as an independent execution device. For example, in a cluster computing environment, a single node may include the electronic device 800 and each electronic device 800 may perform data processing and memory management operations.

The node and the electronic device 800 may be an execution entity of a specific task and may play a key role in data processing and transmission in a parallel processing environment. Accordingly, in the described embodiments, the “node” and the “electronic device 800” may be used with the same or similar meaning, as necessary.

In operation 110, the electronic device 800 may receive an application start signal. The application start signal may be generated by a user input, a system command, and/or a preset condition. The electronic device 800 may perform an initialization procedure for executing an application through the signal.

In operation 110, the electronic device 800 may allocate an initial memory space in response to the application start signal and may enable a processor for data processing. For example, the electronic device 800 may set a memory space to be used by each processor to prepare for the execution of the parallel processing program in advance and may generate initialized data structures. The memory space may be used for data transmission and computational tasks.

Additionally, in operation 110, the electronic device 800 may determine a connection state between a network device and a hardware device and may set a data transmission path. This may be a prerequisite for a smooth data transmission task required by the application. For example, in the cluster computing environment, a network connection state between nodes may be inspected and a bandwidth for data transfer may be secured.

In operation 120, the electronic device 800 may perform allocation of a user buffer and data write when starting data transmission in response to the application start signal. The electronic device 800 may determine a memory size for data transmission to allocate the user buffer and may dynamically allocate a buffer having an appropriate size for the efficient memory use. The electronic device 800 may prepare the user buffer to effectively manage memory resources in the data transmission process.

In operation 120, the electronic device 800 in one or more embodiments may determine a maximum memory size in advance and may dynamically allocate the buffer based on the maximum memory size. For example, the electronic device 800 may determine a minimum memory size for data transmission based on a data transmission order list and transmission size information.

In operation 120, the electronic device 800 in one or more embodiments may determine a data writing order by analyzing a memory access frequency occurring during the data transmission. The electronic device 800 of one or more embodiments may prevent a memory bottleneck and may improve the efficiency of a data writing task by preferentially processing an item with high data access frequency. For example, in the parallel processing environment, the electronic device 800 of one or more embodiments may be preferentially write frequently referenced data in the memory and may later process less frequently referenced data, thereby reducing latency in the data transmission process.

In operation 130, the electronic device 800 may determine whether a memory usage pattern that may occur during the data transmission is secured (e.g., is determined). The electronic device 800 may determine whether the memory usage pattern that may occur during the data transmission is secured before transmitting the data. For example, that the memory usage pattern that may occur during the data transmission is “secured” may mean that the memory usage pattern has been determined (e.g., in advance) for implementing the data transmission, such that the data transmission is to be implemented according to the memory usage pattern.

In operation 130, the electronic device 800 may analyze a usage pattern based on a memory usage count, an access frequency, and a transmission order during the data transmission process. Through this analysis, a memory usage characteristic that iteratively occurs in the data transmission task may be identified.

In operation 130, the electronic device 800 in one or more embodiments may analyze a new memory usage pattern in a process of securing a data space before the data transmission and may determine whether to store the pattern. The memory usage pattern may be defined as a concept that embraces characteristics such as a memory size iteratively shown in the data transmission task, a usage count, an access order, and a transmission order. The electronic device 800 may secure information for optimizing the data transmission task by determining whether the memory usage pattern is secured.

When there is no secured memory usage pattern, the electronic device 800 may generate a new pattern based on at least one of a memory access frequency, a memory space allocation order in the memory, and a transmission order and may store the new pattern. For example, the electronic device 800 of one or more embodiments may set to record a frequently used memory space when data transmission is randomly performed in the parallel processing environment and allocate the frequently used memory space preferentially for future data transmission, thereby improving the accuracy in memory management when transmitting the data.

In the parallel processing environment, not only the transmission order but the allocation order of the internal memory space may affect data management and performance. The electronic device 800 of one or more embodiments may improve a utilization rate of the memory space and the management accuracy in data transmission by optimizing the memory allocation order.

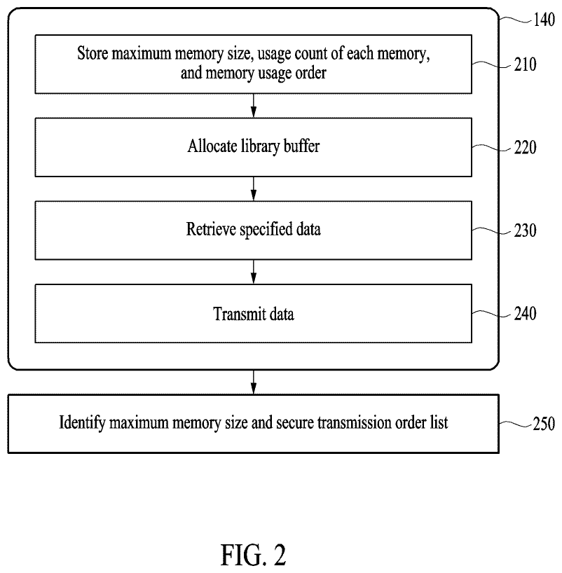

An example of this is further described with reference to FIG. 2 that describes an operation when the memory usage pattern is not secured.

In operation 140, when the memory usage pattern is not determined based on the determination, the electronic device 800 may perform an iterative pattern storage process of identifying an iterative pattern and storing the pattern. An example of the iterative pattern storage process is further described with reference to FIG. 2 below.

In operation 150, the electronic device 800 may provide the transmission order and memory information based on a determination result and the memory usage pattern. The electronic device 800 of one or more embodiments may optimize memory allocation for data transmission and the transmission order by analyzing memory usage information in the secured memory usage pattern and/or a memory transmission pattern secured by the iterative pattern storage process.

The electronic device 800 of one or more embodiments may efficiently allocate a memory buffer based on the memory information. For example, by referring to a data size of a transmission target and a transmission order list, the electronic device 800 of one or more embodiments may reuse a memory space that is already used and/or may minimize a memory size to be newly allocated.

Additionally, the electronic device 800 in one or more embodiments may analyze a data flow between transmission target nodes to improve the efficiency of data transmission and may adjust the transmission order. For example, the electronic device 800 of one or more embodiments may preferentially allocate a node-to-node communication path in which data transmission is frequently performed and/or may reduce the latency by adjusting the transmission order according to the data size.

The electronic device 800 of one or more embodiments may also optimize a network bandwidth by a combination of the transmission order and the memory information. For example, the electronic device 800 of one or more embodiments may preemptively prevent a possible collision in the data transmission path by rearranging the order of each transmission task and/or setting access priority permission to a frequently used memory area, thereby improving the data transmission efficiency.

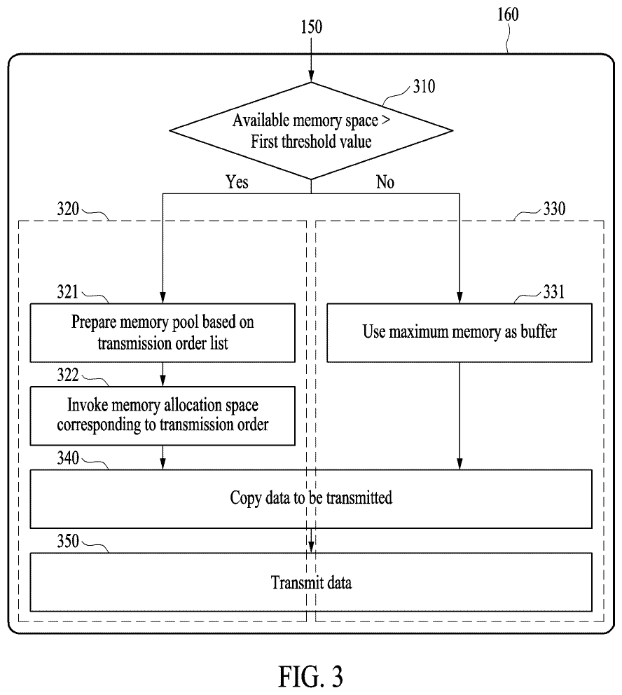

In operation 160, the electronic device 800 may transmit the data based on the transmission order and the memory information. An example of the operation of transmitting the data is further described with reference to FIG. 3 below.

FIG. 2 is a schematic flowchart illustrating a process of storing an iterative pattern according to one or more embodiments. Operations 210 to 250 of FIG. 2 may be performed in the sequence and manner as illustrated in FIG. 2. However, one or more of the operations may be performed in a different order, one or more of the operations may be omitted, two or more of the operations may be performed in parallel or simultaneously, and/or other operations may be additionally performed without departing from the spirit and scope of the described embodiments.

The description provided with reference to FIG. 1 may apply to the example of FIG. 2, and a repeated description may be omitted.

An iterative pattern storage process 140 in one or more embodiments may be performed through operations 210 to 240.

In operation 210, the electronic device 800 may store a maximum memory size, a usage count of each memory, and a memory usage (or allocation) order. The electronic device 800 may analyze a memory area to be used for data transmission and may store the size of each memory and a usage frequency. The stored size and usage frequency of the memory may be used to optimize and allocate a memory resource based on the data transmission pattern.

The electronic device 800 may also analyze the data size to be used for the transmission task and the transmission order and may identify an iteratively used memory and a frequently accessed memory area. For example, The electronic device 800 may record the usage count of a memory space that stores the data when the data is periodically transmitted in a parallel processing environment. Subsequently, when transmitting the same data, the electronic device 800 may preferentially utilize the corresponding memory area and/or use it for reuse.

In operation 220, the electronic device 800 may dynamically allocate a library buffer based on a storage result. The electronic device 800 may allocate a buffer having an appropriate size and location for the data transmission task by analyzing the maximum memory size, the usage count of each memory, and the memory usage order data stored in operation 210.

In operation 230, the electronic device 800 may retrieve specified data from a data source device by accessing the library buffer. The electronic device 800 may copy or transmit data to the library buffer by referring to a memory location connected to the data source device in a node.

In operation 230, the electronic device 800 in one or more embodiments may retrieve specified data based on a memory address and the data size information of the data source device. For example, the electronic device 800 may identify data stored in a graphics processing unit (GPU) memory and may fetch the data to the library buffer.

In operation 240, the electronic device 800 may transmit the data to a transmission target node or device. In response to the electronic device 800 storing the data fetched in operation 230 in the library buffer, the electronic device 800 may perform the data transmission task based on the transmission order list and the memory information. The transmission target node may be another electronic device 800 in the same node or may be an external node connected via a network.

The electronic device 800 that transmits the data through the aforementioned operations may store an iterative pattern by storing the memory usage pattern.

As described below, the electronic device 800 in one or more embodiments may improve the transmission efficiency based on the usage frequency of the memory size when transmitting the data. When the same memory size is frequently used, by reusing a buffer having the memory size, the electronic device 800 of one or more embodiments may reduce waste of memory resources and/or may stably transmit the data when the memory area is limited. For example, when the data having the same size is to be iteratively processed, the electronic device 800 of one or more embodiments may maintain and/or reuse the buffer having the same memory size without releasing to transmit the data having the same size.

In response to the data transmission and iterative pattern storage process being completed, in operation 250, the electronic device 800 may identify the maximum memory size and may secure the transmission order list. The electronic device 800 may identify the maximum memory size again and may update a transmission order list to be used for future data transmission by analyzing the memory size and the transmission order data used in the data transmission process.

Accordingly, in response to the electronic device 800 identifying a pattern of memory usage, the electronic device 800 of one or more embodiments may identify a frequently used memory size when transmitting the data and may configure an efficient memory usage strategy based thereon. For example, when the same memory size is iteratively used, the electronic device 800 may maintain a buffer for a memory space having the size and may reuse the buffer in the next data transmission task.

The electronic device 800 of one or more embodiments may optimize future data transmission through the transmission order list. For example, the electronic device 800 may designate a priority of data transmission by transmission target node or device and/or may reconstruct the order to minimize the memory usage. The electronic device 800 of one or more embodiments may improve the efficiency and speed of data transmission in the parallel processing environment by implementing the list.

FIG. 3 is a flowchart illustrating a data transmission process according to one or more embodiments. Operations 310 to 350 of FIG. 3 may be performed in the sequence and manner as illustrated in FIG. 3. However, one or more of the operations may be performed in a different order, one or more of the operations may be omitted, two or more of the operations may be performed in parallel or simultaneously, and/or other operations may be additionally performed without departing from the spirit and scope of the described embodiments.

The description provided with reference to FIGS. 1 and 2 may apply to the example of FIG. 3, and a repeated description may be omitted.

In operation 310, when an available memory space exceeds (e.g., is greater than) a threshold value, the electronic device 800 may perform an asynchronous data transmission process 320. Further, in operation 310, when the available memory space is less than or equal to the threshold value, the electronic device 800 may perform a synchronous data transmission process 330.

The asynchronous data transmission process 320 may be performed through operations 321, 322, 340, and 350.

In operation 321, the electronic device 800 may prepare a memory pool based on a transmission order list. The memory pool may be dynamically adjusted according to the available memory space.

In operation 322, the electronic device 800 may invoke a memory allocation space corresponding to the transmission order.

During the node-to-node data transmission, by reusing the previously prepared memory space, the electronic device 800 of one or more embodiments may reduce the time taken for space allocation without generating a new memory space each time. By preparing a memory pool in advance based on a memory delivery order list secured in a first iteration, the electronic device 800 of one or more embodiments may efficiently utilize resources in the future data transmission process.

When a memory space is insufficient (e.g., when the memory space is determined to be less than a threshold value) in the memory pool preparation process, the electronic device 800 may generate a memory space during a waiting time after network transmission. When the memory space is insufficient, a space that is redundantly allocated among the total used memory space may be selectively prepared. For example, when the data transmission order is 10, 2, 10, 5, 20, 30, 2, 7, 10, the electronic device 800 of one or more embodiments may set to secure only the memory spaces of 10, 2, 5, 20, 30, 7, thereby minimizing waste of memory spaces.

Additionally, when transmitting data asynchronously, same memory spaces that are consecutively used may be combined as one and may not be used. For example, when the data transmission order is 3, 2, 2, 4, the electronic device 800 of one or more embodiments may process the consecutive 2 as a separate memory space, thereby reducing the memory access latency and more smoothly performing the data transmission task.

The memory pool may refer to a set of memory spaces allocated in advance to efficiently perform the memory transmission task. The memory pool may be configured based on the memory size and transmission order to be used for data transmission.

The memory pool may dynamically allocate or invoke the memory according to the transmission order list. When the memory space is insufficient, the same memory size may be reused and/or a space may be secured by releasing a memory of less important data.

The synchronous data transmission process 330 may be performed through operations 331, 340, and 350.

In operation 331, the electronic device 800 may use a maximum memory as a buffer based on the transmission order list and the memory information. The electronic device 800 may perform data transmission using a max memory buffer that sets the maximum memory size as a single buffer, based on the memory size and transmission order to be used for the data transmission process.

The max memory buffer may be a scheme that integrates and manages memory spaces to be used for data transmission into a single buffer and may secure a usage order of the memory in advance through the transmission order list. By using the max memory buffer, the electronic device 800 of one or more embodiments may reduce the time to iteratively allocate and/or release a memory during the data transmission task. For example, when the data transmission order is 10, 15, 20, the electronic device 800 may process all data in a same buffer by generating a memory buffer corresponding to 20, which is the maximum size.

By using the max memory buffer, the electronic device 800 of one or more embodiments may improve the utilization of memory resources in the data transmission task. By using a single buffer, the electronic device 800 of one or more embodiments may reduce overhead associated with memory allocation and deallocation and may improve the data transmission speed. For example, when each transmission task is sequentially performed in the synchronous data transmission, the electronic device 800 of one or more embodiments may perform the data transmission process more efficiently using the max memory buffer.

The electronic device 800 of one or more embodiments may also stably manage memory resources in a large-scale data transmission task using the max memory buffer. When the memory space is extremely insufficient, the buffer may be optimized based on the existing data transmission order or the memory space may be secured by preferentially processing less used data.

In the operation described above, the electronic device 800 may determine whether to use the memory pool or the max memory buffer according to arbitrarily set transfer data and the transmission. The electronic device 800 of one or more embodiments may perform the data transmission task by selecting a more efficient memory management scheme according to the memory transmission scheme and transmission size. For example, when the data transmission size is small or multiple data transmission tasks are asynchronously performed in parallel, the memory pool may be used. On the other hand, when the data size is great or the transmission is synchronously and sequentially performed, the data transmission may be processed in a single memory space.

Additionally, when the available memory is insufficient, the electronic device 800 in one or more embodiments may manage the data transmission task using double buffering. In this case, the electronic device 800 may release a memory used for previously transmitted data in network communication and may secure a memory space for new data.

When the available memory is insufficient, the electronic device 800 may set to use a memory space having the same size iteratively based on a total memory list to be secured. For example, when data having the same size is frequently repeated in the data transmission task, the electronic device 800 of one or more embodiments may reduce memory space waste by reusing the memory space having the same size.

When the data is communicated by a send-receive scheme in a node (intra-node), the electronic device 800 may process the data using only one max memory buffer. In this case, by transmitting the data in the same node, the electronic device 800 of one or more embodiments may improve the task efficiency by transmitting and receiving the data in a single memory buffer without additional memory pool management.

In operation 340, the electronic device 800 may copy data to be transmitted according to the asynchronous data transmission process 320 and/or the synchronous data transmission process 330. The electronic device 800 may perform a copy task based on the transmission order list and the memory information and in the asynchronous scheme, the electronic device 800 may perform copy processes in parallel to perform each data transmission task independently. On the other hand, in the synchronous scheme, the electronic device 800 may sequentially copy the data to prevent a memory collision or data loss.

The electronic device 800 according to one or more embodiments may minimize copying time by optimizing the data size and the memory location during the copy task. For example, when the data having the same size is iteratively transmitted, the electronic device 800 may reuse the same memory space or may perform the copy task using the max memory buffer.

In operation 350, the electronic device 800 may transmit the copied data. The electronic device 800 may transmit the copied data to a transmission target node or device, and in the asynchronous scheme, multiple data transmission tasks may be performed in parallel. In the synchronous scheme, transmission tasks may be sequentially performed and the transmission process may be managed so that each data reaches a transmission target.

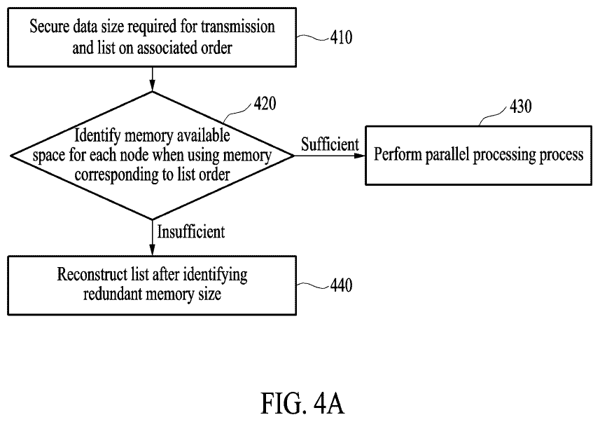

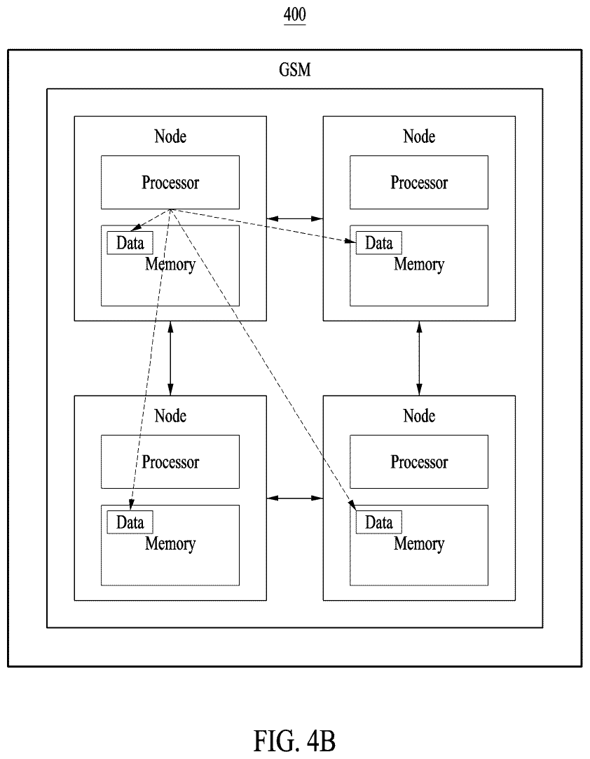

FIGS. 4A and 4B are schematic diagrams illustrating a memory management method when a single shared memory buffer is used using a global shared memory (GSM), according to one or more embodiments. Operations 410 to 440 of FIG. 4A may be performed in the sequence and manner as illustrated in FIG. 4A. However, one or more of the operations may be performed in a different order, one or more of the operations may be omitted, two or more of the operations may be performed in parallel or simultaneously, and/or other operations may be additionally performed without departing from the spirit and scope of the described embodiments.

The description provided with reference to FIGS. 1 to 3 may apply to the example of FIG. 4, and a repeated description may be omitted.

Referring to FIGS. 4A and 4B, the electronic devices 800 in one or more embodiments may generate a single shared memory buffer using a GSM 400 when transmitting data, and the electronic devices 800 may allocate a memory space corresponding to an access frequency when a memory read/write task occurs among the multiple electronic devices 800. For example, the electronic device 800 may preferentially allocate a memory space to a node with a highest access frequency.

For example, referring to FIG. 4B, an operation of the GSM 400 in a plurality of nodes (e.g., the electronic devices 800) may be schematically identified.

In a typical method, data may need to be transmitted to process the data by each node or provide the data to another node. When data of a transmission node is transmitted to a reception node via a network, the data may be stored in a local memory of the reception node and then a processor of the reception node may read or modify the data. This data transmission scheme may include data copying and storing processes via the network.

In contrast to the typical method, in the GSM 400 of one or more embodiments, a processor of each node may directly read or write a memory of another node without data transmission between nodes. Each node may access a globally shared memory space and may not perform network transmission or data copying to read the data. For example, when a processor of a first node is to use data stored in a third node, in the GSM 400, reading and/or modifying the data may be allowed by directly accessing the memory of the third node without network transmission.

Accordingly, by using the globally shared memory space in the GSM 400, the electronic device 800 (e.g., a node) of one or more embodiments may prevent duplicated data storage between nodes and may efficiently use the memory resources. Additionally, by not physically transmitting the data via the network, the electronic device 800 of one or more embodiments may reduce the latency due to data transmission. By performing data access directly between processors of the nodes, the electronic device 800 of one or more embodiments may prevent a data bottleneck in the parallel processing environment. Additionally, by not copying and transmitting the data, the electronic device 800 of one or more embodiments may reduce the usage of network bandwidth and overhead.

Referring to FIG. 4A, individual operations of the electronic device 800 are schematically described in a flowchart.

In operation 410, the electronic device 800 may identify an order list associated with a data size to be used for transmission. The order list may define a shared memory requirement to be used for a data transmission task in the GSM 400 and may provide information for optimizing the transmission task based on each data size and the transmission order.

In operation 420, the electronic device 800 may identify availability of a memory space of each node when using a memory corresponding to a list order. When the available space is sufficient (e.g., when the available space is determined to be greater than or equal to a threshold value), the electronic device 800 may perform a parallel processing process (operation 430) and the data transmission task may be performed. In the parallel processing environment, a memory resource for simultaneously processing data may be important and the electronic device 800 of one or more embodiments may prevent a problem that may occur during the data transmission by inspecting a memory state in advance.

In operation 440, when the memory space is insufficient, the electronic device 800 may identify a redundant memory space and may optimize the insufficient memory by reconstructing the order list. For example, by iteratively transmitting the data having the same size and reconstructing the list to share the same memory size, the electronic device 800 of one or more embodiments may save the resources.

The parallel processing process performed in operation 430 may be a task for rapidly processing the data transmitted from each node and may serve to optimize the memory space and the memory transmission speed. By performing the parallel processing, the electronic device 800 of one or more embodiments may reduce a delay in data transmission, may increase a throughput, and may improve the performance of a system in a large-scale data processing environment.

Each of the electronic devices included in the parallel processing system (e.g., the GSM 400) may include one or more processors. In this case, each of the electronic devices may secure a data size to be used for a data transmission task and an associated order list. According to the order list, an availability of a memory space of each of the electronic devices may be determined. When each of the electronic devices determines that the memory space is sufficient as a result of determination, each of the electronic devices may perform the parallel processing process according to the order list. When each of the electronic devices determines that the memory space is insufficient as a result of determination, each of the electronic devices may reconstruct the order list by identifying a redundant memory size and may perform the parallel processing process based on the reconstructed order list.

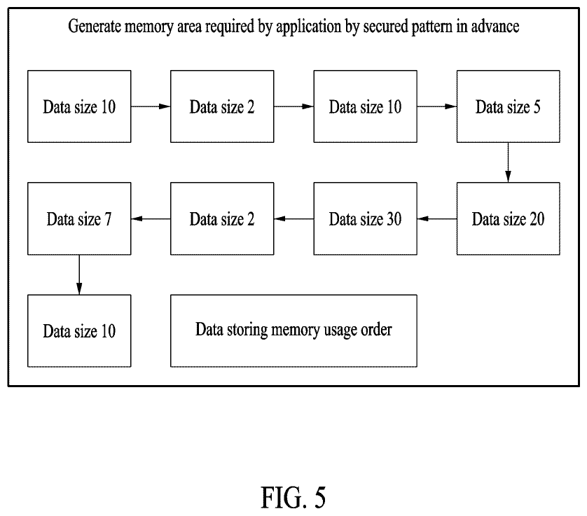

FIGS. 5 to 7 are schematic diagrams illustrating a data transmission process according to an available memory area.

The description provided with reference to FIGS. 1 to 5 may apply to the examples of FIGS. 5 to 7, and a repeated description may be omitted.

Referring to FIG. 5, a method of using a memory pool when a memory space is sufficient may be identified. Depending on a secure memory usage pattern, a memory space to be used for an application may be generated in advance and this may be connected in the form of a list. The electronic device 800 may not iteratively generate a memory space when transmitting data and may reduce the time used for memory allocation by using the pre-generated memory space. For example, when transmitting the data size in the order of 10, 2, 10, 5, 20, 30, 2, 7, and 10, the memory space may be allocated based on the same data size to perform efficient resource management.

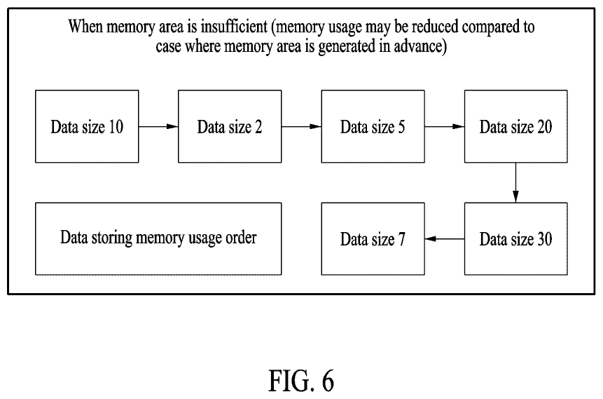

Referring to FIG. 6, a method of using a memory pool when a memory space is insufficient may be identified. When the memory space is insufficient, the electronic device 800 may adjust a memory pool to prevent duplicate memory allocation in a data transmission process. When data having the same size is iteratively used according to the secured memory usage pattern, the electronic device 800 may not allocate a memory space having the same size and may reuse it.

For example, when the data size is transmitted in the order of 10, 2, 10, 5, 20, 30, 2, 7, and 10, the electronic device 800 may identify that the data sizes 10 and 2 are iteratively shown and may reconstruct the memory space efficiently based thereon (e.g., such that the data size is transmitted in the order of 10, 2, 5, 20, 30, and 7). Accordingly, the memory space corresponding to the memory sizes 10 and 2 may not be redundantly allocated and the electronic device 800 of one or more embodiments may reduce the waste of memory resources by reusing a previously allocated memory.

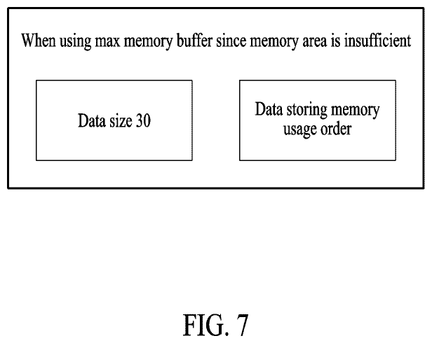

Referring to FIG. 7, a method of using a max memory buffer when a memory space is extremely insufficient (e.g., when the memory space is determined to be less than another threshold value, the other threshold being less than the threshold used to determine that the memory space is insufficient) or large data is numerously used and transmitted. When the memory space is extremely insufficient and/or large data is numerously transmitted, the max memory buffer may be used. The electronic device 800 may process all data by generating a single memory buffer based on a largest memory size in the data transmission task. For example, a buffer may be set based on 30, which is a maximum value of the data size, and through this, the data transmission may be performed. By using the max memory buffer, the electronic device 800 of one or more embodiments may reduce the complexity of memory management and may significantly improve the data transmission speed.

FIG. 8 is a block diagram of an electronic device according to one or more embodiments.

The description provided with reference to FIGS. 1 to 7 may identically apply to the example of FIG. 7, and a repeated description may be omitted.

Referring to FIG. 8, the electronic device 800 according to one or more embodiments may include a processor 830 (e.g., one or more processors), a memory 850 (e.g., one or more memories), and an output device 870 (e.g., a display). The processor 830, the memory 850, and the output device 870 may be connected to each other via a communication bus 805. The electronic device 800 may include the processor 830 configured to perform at least one of the methods described above or an algorithm corresponding to the at least one method for the operations of the electronic device 800.

The output device 870 may display a target path and a control result provided by the processor 830. The output device 870 may be the same device as the display included in the electronic device 800. In addition, the output device 870 may be built into the electronic device 800 or may be an external display device for displaying the target path and the control result.

The memory 850 may store data related to the path tracking method performed by the processor 830 and relevant data. In addition, the memory 850 may store a variety of information generated in a processing process of the processor 830 described above. In addition, the memory 850 may store a variety of data and programs. The memory 850 may include a volatile memory or a non-volatile memory. The memory 850 may include a large-capacity storage medium such as a hard disk to store a variety of data.

In addition, the processor 830 may perform at least one method described above with reference to FIGS. 1 to 7 or an algorithm corresponding to the at least one method. In the above descriptions, the processor 830 may be a data processing device implemented by hardware including a circuit having a physical structure to perform desired operations. For example, the desired operations may include code or instructions included in a program. The processor 830 may be configured as, for example, a central processing unit (CPU), a graphics processing unit (GPU), and/or a neural network processing unit (NPU). For example, the hardware-implemented electronic device 800 may include a microprocessor, a CPU, a processor core, a multi-core processor, a multiprocessor, an application-specific integrated circuit (ASIC), and a field-programmable gate array (FPGA).

The processor 830 may execute a program and may control the electronic device 800. Program codes to be executed by the processor 830 may be stored in the memory 850. For example, the memory 850 may be or include a non-transitory computer-readable storage medium storing code that, when executed by the processor 830, configures the processor 830 to perform any one, any combination, or all of the operations and/or methods described herein with reference to FIGS. 1-8.

The GSMs, electronic devices, processors, memories, output devices, communication buses, GSM 400, electronic device 800, processor 830, memory 850, output device 870, and communication bus 805 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD−Rs, DVD+Rs, DVD-RWs, DVD−RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
allocating a user buffer and performing data read when starting data transmission in response to an application start signal;
determining whether a memory usage pattern to occur in the data transmission is secured;
providing a transmission order and memory information based on a result of the determination and the memory usage pattern; and
transmitting data based on the transmission order and the memory information.

2. The method of claim 1, wherein the allocating of the user buffer and the performing of the data read comprises pre-determining a maximum memory size and dynamically allocating a buffer based on the size.

3. The method of claim 1, wherein the allocating of the user buffer and the performing of the data read comprises determining a data write order by analyzing a data access frequency that occurs during the data transmission.

4. The method of claim 1, further comprising, in response to the memory usage pattern not being identified according to the determination, performing an iterative pattern storage process of identifying and storing an iterative pattern.

5. The method of claim 4, wherein the iterative pattern storage process comprises:
storing a maximum memory size, a usage count of each memory, and a memory usage order;
dynamically allocating a library buffer based on a storage result;
retrieving data specified by a data source device by accessing the library buffer; and
transmitting the specified data to a transmission target node or device.

6. The method of claim 5, wherein the performing of the iterative pattern storage process comprises, in response to the data transmission being completed, identifying a maximum memory size and securing a transmission order list.

7. The method of claim 1, wherein the transmitting of the data based on the transmission order and the memory information comprises:
in response to an available memory space exceeding a threshold value, performing an asynchronous data transmission process; and
in response to the available memory space being less than or equal to the threshold value, performing a synchronous data transmission process.

8. The method of claim 7, wherein the asynchronous data transmission process comprises:
preparing a memory pool based on the transmission order list; and
invoking a memory allocation space corresponding to the transmission order.

9. The method of claim 8, wherein the memory pool is dynamically adjusted corresponding to the available memory space.

10. The method of claim 7, wherein the synchronous data transmission process comprises using a maximum memory as a buffer based on the transmission order list and the memory information.

11. The method of claim 7, further comprising:
copying data to be transmitted according to the asynchronous data transmission process or the synchronous data transmission process; and
transmitting the copied data.

12. The method of claim 1, wherein the transmitting of the data based on the transmission order and the memory information comprises:
generating a single shared memory buffer using a global shared memory (GSM); and
in response to a memory read/write task occurring among multiple nodes, allocating a memory space corresponding to an access frequency.

13. An electronic device comprising:
one or more processors configured to:
allocate a user buffer and perform data read when starting data transmission in response to an application start signal;
determine whether a memory usage pattern to occur in the data transmission is secured;
provide a transmission order and memory information based on a result of the determination and the memory usage pattern; and
transmit data based on the transmission order and the memory information.

14. The electronic device of claim 13, wherein, for the allocating of the user buffer and the performing of the data read, the one or more processors are configured to pre-determine a maximum memory size and dynamically allocate a buffer based on the size.

15. The electronic device of claim 13, wherein, for the allocating of the user buffer and the performing of the data read, the one or more processors are configured to determine a data write order by analyzing a data access frequency that occurs during the data transmission.

16. The electronic device of claim 13, wherein the one or more processors are configured to, in response to the memory usage pattern not being identified according to the determination, perform an iterative pattern storage process of identifying and storing an iterative pattern.

17. The electronic device of claim 16, wherein, for the iterative pattern storage process, the one or more processors are configured to:
store a maximum memory size, a usage count of each memory, and a memory usage order;
dynamically allocate a library buffer based on a storage result;
retrieve data specified by a data source device by accessing the library buffer; and
transmit the specified data to a transmission target node or device.

18. The electronic device of claim 17, wherein, for the performing of the iterative pattern storage process, the one or more processors are configured to, in response to the data transmission being completed, identify a maximum memory size and secure a transmission order list.

19. The electronic device of claim 13, wherein, for the transmitting of the data based on the transmission order and the memory information, the one or more processors are configured to:
in response to an available memory space exceeding a threshold value, perform an asynchronous data transmission process; and
in response to the available memory space being less than or equal to the threshold value, perform a synchronous data transmission process.

20. A parallel processing system comprising:
a plurality of electronic devices each comprising one or more processors,
wherein, for each of the electronic devices, the one or more processors comprised in the electronic device are configured to:
secure a data size to be used for a data transmission task and an associated order list;
determine availability of a memory space of each of the plurality of electronic devices according to the order list;
in response to determining that the memory space is sufficient as a result of the determination, perform a parallel processing process based on the order list;
in response to determining that the memory space is insufficient as a result of the determination, perform the parallel processing process based on a reconstructed order list by identifying a redundant memory size and reconstructing the order list.
